(19) United States
(12) Patent Application Publication
(10) Pub. No.: US 2006/0060446 A1
(43) Pub. Date: Mar. 23, 2006

(54) System with stationary and mobile functional devices

(76) Inventor: Gerhard Springmann, Kleinostheim (DE)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/225,983

(22) Filed: Sep. 14, 2005

(30) Foreign Application Priority Data
Sep. 20, 2004 (DE) 10 2004 045 517.1

(51) Int. Cl. B65G 37/00

(52) U.S. Cl. 198/347.1

(57) ABSTRACT

The invention relates to a system with stationary and mobile functional devices. In one embodiment the system comprises a buffer store for the intermediate storage of load carriers having a plurality of parking places for the load carriers. The parking places are formed, for example, as chain conveyers and arranged beside one another in one or more rows. The parking places can be served by a distribution carriage moved along a row of conveyors. The distribution carriage has a transfer device, adapted to transfer a load carrier to a parking place or picked up from the latter. The stationary conveyors each have their own electric drive, it being possible for the electrical power for driving a conveyor to be fed in under individual control by the distribution carriage in each case, when the latter has reached a transfer position to the respective stationary conveyor. For this purpose, corresponding bus bars can be provided in the region of the parking places and feed contacts corresponding thereto with the effect of sliding contacts can be provided on the distribution carriage. However, non-contact transmission of electrical drive power and control signals between the distribution carriage and the stationary conveyors is also possible.

### BACKGROUND AND FIELD OF THE INVENTION

The invention relates to a system with stationary and mobile functional devices.

Buffer stores for the intermediate storage of load carriers such as pallets, on which goods can be transported and stored, are often needed in order to be able to configure specific operating sequences optimally. For instance, they are often used in the order-picking area of high-bay stores and are then used to be able to perform the order of the removal of individual load carriers from the high-bay storage area independently of the requirements of the order configuration in the order-picking area, where goods for assembling individual jobs have to be removed from the individual load carriers. The removal order for individual load carriers from the high-bay store by means of the respective storage and retrieval device can therefore be optimized without regard to the exact sequence during the removal of goods in the order-picking area, in order to ensure the maximum throughput for the entire storage system including order-picking area.

Often used as buffer stores for the intermediate storage of load carriers are simple frames, on which the individual load carriers can be parked temporarily in each case following the removal from the high-bay store, until they are actually needed within the context of the order picking. The parking places for the load carriers in such a buffer store can be loaded and unloaded, for example, by means of a distribution carriage having the load carriers which, for example, can be pallets of any desired type, in particular standard pallets, or cages or else trays. Such a distribution carriage, which forms a mobile functional or transport device, is expediently equipped with a telescopic fork for handling the load carriers. Although a simple buffer store of this type only requires little expenditure on construction, on the other hand it permits only a relatively low transfer speed and thus a low throughput.

In order to increase the transfer speed and thus also the throughput, it is known to arrange a large number of relatively short conveyors in a row beside one another, on which in each case the load carriers can be set down, instead of rigid parking places on which the load carriers can be stored temporarily. These short conveyor sections, which are constructed as chain conveyors, for example, and thus in each case form a stationary functional or transport device, are usually dimensioned such that there is space for only a single load carrier thereon. However, in principle it is possible also to use somewhat longer portions of conveyor sections, on which in each case there would be space for a plurality of load carriers. The operation of the individual parking places is in this case again carried out by means of one or, if appropriate, else a plurality of distribution carriages, which can be moved past these conveyor sections in an aisle between mutually opposite rows of conveyor sections arranged beside one another with parallel spacing. Such a distribution carriage is likewise equipped with a short conveyor section part, which forms the transfer apparatus for transferring or picking up a load carrier to or from a parking place. In many cases, the distribution carriage is provided with two conveyor sections arranged beside each other, in order to be able to pick up or discharge two load carriers simultaneously in a single cycle or to discharge one load carrier and to pick up another simultaneously. A conveyor on the distribution carriage thus represents a mobile conveyor, while the conveyors of the parking places are stationary and, as distinct from the mobile conveyor, normally do not have their own motor drive (e.g. three-phase motor with frequency converter). In order never-theless to be able to move the conveyors of the parking places when transferring or picking up load carriers, it is known to equip the distribution carriage with what is known as a friction wheel which, in the respective transfer position, in which the conveyor of the parking place and the mobile conveyor are aligned with one another and opposite one another at a short distance, can be pivoted out in the direction of the stationary conveyor and can be brought into a mechanical drive connection with a corresponding friction wheel of the stationary conveyor. In each case a few seconds are needed for pivoting in and out when docking and undocking the friction wheel, which increase the cycle time significantly for a storage or removal operation of the buffer store. This solution is therefore suitable only for medium outputs.

In order to achieve the maximum efficiency and therefore the shortest cycle times in a buffer store for the intermediate storage of load carriers, it is necessary to provide the stationary conveyors forming the parking places with their own drives in each case. However, hitherto, considerable additional expenditure has been associated with this, which relates in particular to the parts of the system for supplying the drive motors with drive power and the control of the drive motors. In particular, the cabling for power and control lines and the necessary switch cabinets require considerable expenditure on construction and a great deal of space.

In a system with stationary and mobile functional devices which are provided with electrical loads, the supply of the electrical loads on the stationary functional devices is generally provided via a stationary power feed, particularly since the production of electrical power is carried out to the greatest extent in stationary power stations and the power distribution via stationary networks. Mobile functional devices such as a trailer on a campsite are likewise operated with a power feed from a stationary network during a major part of their use.

### SUMMARY OF THE INVENTION

It is an object of the invention, in a generic system, to reduce the expenditure necessary for the power supply and for the activation of drives.

According to the invention, this object is achieved in a system containing at least one mobile functional device and a plurality of stationary functional devices, all of which have an electrical load that can be fed by a power supply, by supplying the power supply to at least one of the stationary functional devices by the at least one mobile functional devices. Advantageous refinements of the invention are indicated in the claims.

In the present invention the power supply, at least in some of the stationary functional devices, is not provided in a stationary manner but via at least one mobile functional device. As a result, the expenditure on cabling and control engineering can be reduced drastically. In this case, use is made of the fact that the respective stationary functional device only has to be capable of electrical operation when the mobile functional device corresponds operationally with it.

The present invention, which can be used in an extremely wide range of systems, is employed in one application in a buffer store for the intermediate storage of load carriers where there exists a large number of parking places for at least one load carrier in each case, at least some of the parking places being constructed as stationary conveyors. In this buffer store, the load carriers can optionally be transferred to the respective stationary conveyor and picked up from the latter by means of at least one distribution carriage which can be moved along the parking places arranged beside one another in at least one row. The electric drive power for the stationary conveyors, which have their own electric motor to drive them, is not provided in the conventional way from outside by means of feed lines laid in a stationary manner but is fed in under individual control by the distribution carriage or carriages when the respective distribution carriage has reached its transfer or pick-up position in relation to the respective stationary conveyor of the parking place. The power feed is therefore provided by the distribution carriage itself, which, for this purpose, is provided with appropriate feed contacts, for example, while the stationary conveyors are equipped with appropriate bus bars for the production of a temporary electrical connection. In the same way as the power transmission, a signal transmission can also be carried out if required, in order to control the motor drives. Of course, within the context of the invention, it is also possible to provide non-contact transmission of drive power and, if appropriate, also of control signals, instead of conventional contacts via bus bars and feed contacts. This can involve inductive power and signal transmission through non-contact power transmission devices such as inductive couplers.

These and other objectives, advantages, purposes, and features of the present invention will become apparent upon review of the following specification in conjunction with the drawings.

### BRIEF DESCRIPTION OF THE DRAWINGS

FIG. 1 is a perspective view of a buffer store constructed in accordance with the present invention; and

FIG. 2 is a front elevational view of the buffer store of FIG. 1.

### DESCRIPTION OF THE PREFERRED EMBODIMENTS

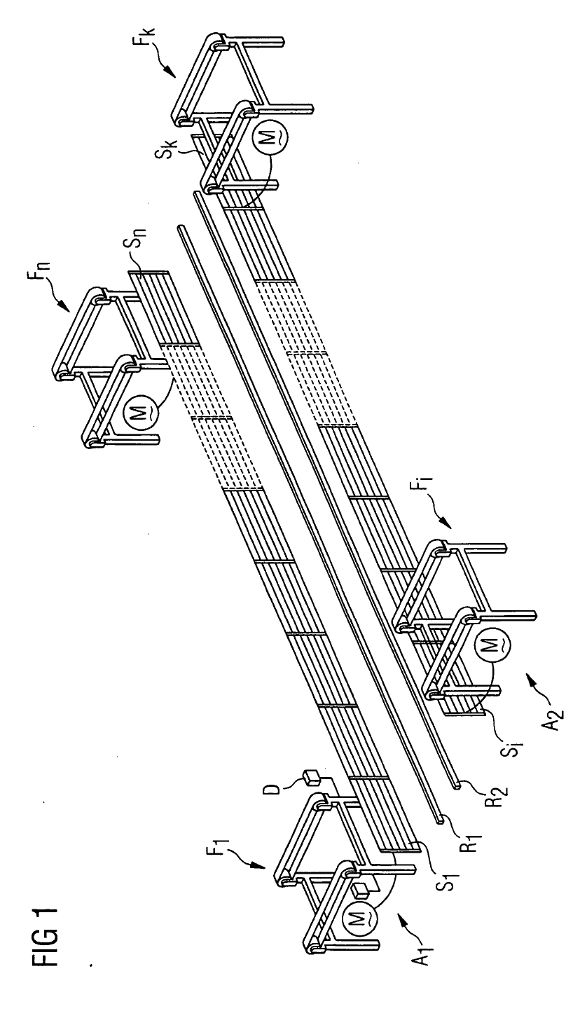

The buffer store illustrated in FIG. 1 has a large number of stationary transport devices formed as parking places, which are each constructed as stationary conveyors and are mounted on frames. The stationary conveyors, which are designated F₁, Fₙ, Fᵢ, Fₖ, are chain or belt conveyors in a preferred embodiment of the invention. In principle, other conveyors, such as roller conveyors, could also be used. In the present case, the conveyors are arranged standing beside one another in each case in two mutually opposite rows A₁ and A₂. In order to simplify the drawing, in each case only the first conveyor F₁, Fᵢ and the last conveyors Fₙ, Fₖ are illustrated in each row A₁, A₂. However, it should be understood that each row A₁, A₂ has further conveyors F, which are in each case arranged relatively close beside one another. Each conveyor F has a drive motor M, which is preferably constructed as an electric drive using a three-phase electric motor and therefore can change its direction of rotation depending on activation. In each case both tracks of the conveyors F are expediently driven. For this purpose, for example, a common drive shaft can be provided. Of course, it would also be possible to provide each track with its own motor drive. Arranged in front of the two rows A₁, A₂ of conveyors F in each case are bus bars S, which are divided up into individual sections, which are assigned to the conveyors F₁, Fₙ, Fᵢ, Fₖ and therefore are correspondingly designated S₁, Sₙ, Sᵢ, Sₖ. The individual bus bar sections S₁-Sₖ are each electrically isolated from one another and, via short cabling laid in a stationary manner, there is a line connection from the respective bus bar section S₁-Sₖ to the respective drive motor M of the stationary conveyor F₁-Fₖ assigned to this section. In the aisle which is formed between the conveyors F₁-Fₙ of the row A₁ and the conveyors Fᵢ-Fₖ of the row A₂, rails R₁, R₂ are laid, which form the movement path of a moving carriage not illustrated in FIG. 1. The partly dashed illustration of the rails R₁, R₂ and of the bus bars S is intended to indicate the undetermined length of the buffer store and the undetermined number of stationary conveyors F.

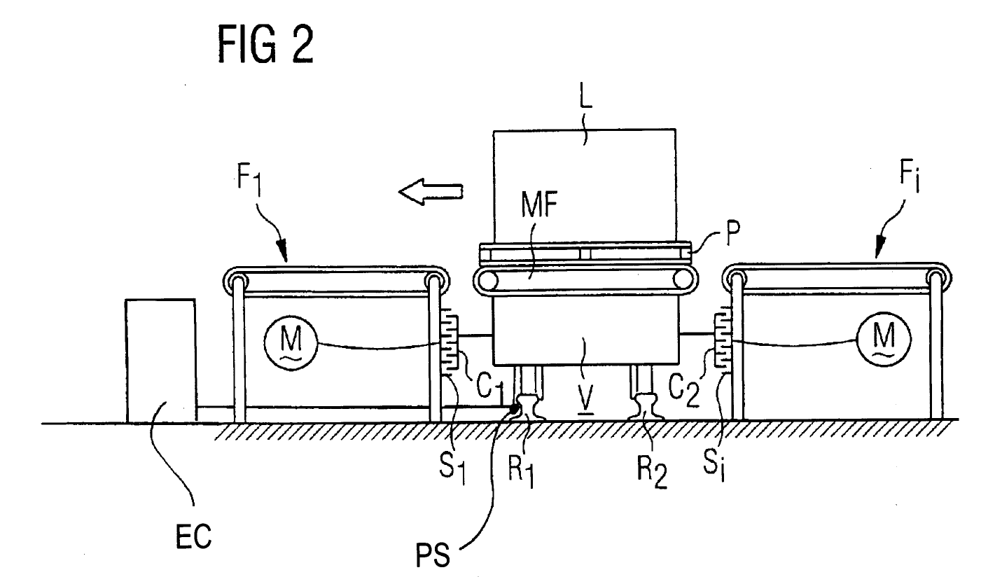

The front view of the buffer store according to FIG. 2 reveals a mobile transport device constructed as a distribution carriage V that can be moved on the two rails R₁, R₂ along the two rows A1, A₂ of stationary conveyors F₁-Fₖ. The distribution carriage V is equipped with a mobile conveyor MF corresponding to the stationary conveyors F₁-Fₖ, which serves as a transfer device for the interchange of load carriers P between the stationary conveyors F₁-Fₖ and the distribution carriage V. The conveying directions of the conveyors F₁-Fₖ and of the mobile conveyor MF are in each case parallel to one another. Of course, it would also be possible to arrange the parking places beside one another in a curve instead of in straight lines A₁, A₂. For the invention, however, it is merely important that the distribution carriage V is guided on its movement path such that its mobile conveyor MF, as it passes a stationary conveyor, can in each case reach a position in which a transfer of a load carrier is possible without difficulty, that is to say in which the tracks of the conveyors F₁-Fₖ and MF are in each case aligned with one another. In FIG. 2, a load carrier P formed as a standard pallet is illustrated on the mobile conveyor MF and carries a load L which, for example, consists of a carton with a large number of identical workpieces (not illustrated). An arrow indicates that this load carrier P is to be stored intermediately by the mobile conveyor MF on the parking place equipped with the stationary conveyor F₁. The distribution carriage V has its own power supply PS (for example via drag cables, sliding contacts or inductively), for its traction drive and for the drive of its mobile conveyor MF. The distribution carriage V is expediently also provided with an electronic controller EC that controls not only the approach to a suitable transfer position to the respective parking place but also the movement of the mobile conveyor MF; this controller EC can be mobile but is expediently arranged in a stationary manner and can also be employed to control other parts of the system.

The view in FIG. 2 reveals not only the sections of the bus bars S₁ to Sᵢ assigned to the two stationary conveyors F₁ and Fᵢ but also the feed contacts C₁, C₂ corresponding to these bus bars S₁, Sᵢ, with which, under the control of its electronic controller EC, the distribution carriage V can feed electrical power selectively into the respectively desired bus bar section S₁, so that the motor M drives the associated conveyor F₁ in the desired drive direction. It order to effect a reversal of the direction of rotation of the motor drive for unloading a load carrier P from a parking place, the controller EC is able to perform a phase exchange in the power supply in a known way. The duration of the respective motor drive and therefore the length of the movement travel effected for the load carrier P is expediently likewise influenced via the electronic controller of the distribution carriage V. For this purpose, in an advantageous development of the invention, a detector device D preferably formed as a light barrier can be provided, for example, on each conveyor F₁-Fₙ and monitors the gap between the respective stationary conveyor F₁ and the mobile conveyor MF, that is to say detects whether a load carrier P has passed this gap or not. The signals from the detector device D can in each case be transmitted, via separate bus bars S for the signal transmission and corresponding sliding contacts on the distribution carriage, to the electronic controller EC of the latter. However, the signal transmission can also be carried out directly via the power transmission lines. Of course, it is also possible, instead of bus bars and feed contacts, to perform the transmission of the electric drive energy and, if appropriate, of signals on a non-contact path between a conveyor F₁-Fₖ and the distribution carriage V, for example by means of non-contact power transmission devices such as, for example, couplers enabling inductive coupling. It is not necessary to provide each parking place with a detector device D. The gap between distribution carriage V and an entire row A₁ or A₂ of stationary conveyors F₁-Fₖ could, however, also be monitored for example in each case by a single light barrier which extends over the entire row A₁, A₂. With regard to minimizing the expenditure on construction, on the other hand, it has proven to be expedient and sufficient to provide a detector device only on the distribution carriage V, which device is advantageously formed as a light barrier device and can determine the presence of a load carrier P on the distribution carriage V and indicate this to the controller. In such a case, the controller EC can be provided with what is known as a follow-up controller, which is capable of operating the motor drive of a stationary conveyor F for a sufficient length of time if the detector device of the distribution carriage determines, in the case of the loading of a parking place, that the respective load carrier P respective load carrier P has left the distribution carriage V or if, in the case of the unloading of a parking place, the load carrier P is passing the gap between the stationary conveyor F and the mobile conveyor MF or is entering the region of the distribution carriage V. The follow-up controller actuates the motor drive for this purpose until the respective load carrier P has reached its intended position on the parking place or on the distribution carriage. In this case, it is not necessary to have the actual reaching of this intended position monitored by a separate sensor in each case, since these are in each case relatively short transport operations, which can be carried out with adequate safety by a simple controller.

In order to avoid a jolting movement of the stationary conveyors F and of the mobile conveyor MF, the use of frequency converters is recommended in order to permit relatively gentle starting of the motors. Since the motors of the stationary conveyors F are always addressed only individually in each case, in order to ensure gentle starting, recourse can nevertheless be had to conventional three-phase motors for their drive; it is sufficient if only one such frequency converter is provided on the distribution carriage and is connected to the electronic controller of the latter, since this frequency converter only has to influence the current to be fed in individually for the drive of the respective motor of the stationary conveyor F. In this way, three-phase control of the three-phase motors can be ensured with very little expenditure on construction.

Of course, it is within the scope of the invention to equip the distribution carriage V with a plurality of parallel conveyor units which can be operated separately, for example with two conveyor units. It is then possible, in a single approach operation, to discharge two load carriers simultaneously to, for example, two parking places lying beside each other or to pick them up from the latter, or to discharge one load carrier and simultaneously to pick up another.

An advantage of the solution according to the invention consists in the fact that it is not only possible to dispense with laying stationary cabling over relatively great distances but that, furthermore, for the control of the drives of the stationary conveyors F, no additional switch cabinets have to be erected and likewise provided with cabling. All the drives of the stationary conveyors F can be influenced without difficulty via the respective electronic controller of the distribution carriage V. This also applies to the case in which a plurality of distribution carriages V is used or the distribution carriage has a plurality of parallel conveyor units. It is also particularly important that the invention renders superfluous the provision of separate controllers, including the software therefor, for the stationary conveyors. This brings with it the further advantage of considerably simpler tests and considerably shorter commissioning times.

Changes and modifications in the specifically described embodiments can be carried out without departing from the principles of the present invention, which is intended to be limited only by the scope of the appended claims, as interpreted according to the principles of patent law including the doctrine of equivalents.

1. A system comprising at least one mobile functional device and a plurality of stationary functional devices, each said at least one mobile functional device and said stationary functional devices having an electrical load that can be fed via a power supply, wherein the power supply to at least one said stationary functional device is provided by said at least one mobile functional device.

2. The system as claimed in claim 1, wherein said at least one mobile functional device is at least one mobile transport device, and wherein said stationary functional devices are stationary transport devices.

3. The system as claimed in claim 2, wherein said system is a buffer store for the intermediate storage of load carriers, said buffer store comprising a plurality of parking places forming said stationary transport devices and arranged beside one another in at least one row, each said parking place adapted to store at least one load carrier, and wherein at least one of said parking places includes a stationary conveyor, said stationary conveyor including an electric drive adapted to drive said stationary conveyor, said buffer store further comprising at least one distribution carriage forming said mobile transport device, said distribution carriage adapted to be moved among the at least one row and being provided with a transfer device, said transfer device adapted to enable a load carrier to be selectively transferred to a said parking place or picked up from said parking place, wherein the electric power for driving said stationary conveyor of said parking places is fed in under individual control by said at least one distribution carriage when said distribution carriage has reached a position relative to said stationary conveyor in which it is possible to transfer or pick up the load carrier.

4. A buffer store for the intermediate storage of load carriers, said buffer store comprising a plurality of parking places arranged beside one another in at least one row, each said parking place adapted to store at least one load carrier, and wherein at least one of said parking places includes a stationary conveyor, said stationary conveyor including an electric drive adapted to drive said stationary conveyor, said buffer store further comprising at least one distribution carriage, said distribution carriage adapted to be moved among the at least one row and being provided with a transfer device, said transfer device adapted to enable a load carrier to be selectively transferred to a said parking place or picked up from said parking place, wherein the electric power for driving said stationary conveyor of said parking places is fed in under individual control by said at least one distribution carriage when said distribution carriage has reached a position relative to said stationary conveyor in which it is possible to transfer or pick up the load carrier.

5. The buffer store of claim 4, wherein said stationary conveyors are constructed as at least one selected from the group consisting of chain, belt and roller conveyors.

6. The buffer store of claim 4, wherein said electric drive of said stationary conveyors comprises a three-phase motor.

7. The buffer store of claim 6, wherein said three-phase motors are each provided with a frequency converter for rotational speed control, the respective said frequency converters being activated via a direct signal transmission from said distribution carriage.

8. The buffer store of claim 6, wherein said three-phase motors of said stationary conveyors are formed without a frequency converter, and wherein a frequency converter is provided on said distribution carriage, said frequency converter being adapted to control the frequency of the feed of the electrical power for a respective said stationary conveyor.

9. The buffer store of claim 4, further comprising bus bars, said bus bars being provided in the region of said parking places that face the movement path of said distribution carriage, said bus bars being divided in accordance with said parking places into sections, said sections being isolated electrically from one another and wired to the power feed of the respective electric drive of said parking place, and wherein said distribution carriage includes feed contacts, said feed contacts being adapted to interact with said sections of said bus bar.

10. The buffer store of claim 4, further comprising non-contact power transmission devices, said devices being provided in the region of said parking places that face the movement path of said distribution carriage, wherein said devices are provided for the non-contact transmission of power between said distribution carriage and said stationary conveyors of said parking places.

11. The buffer store of claim 10, wherein said non-contact power transmission devices are adapted to transmit power inductively.

12. The buffer store of claim 4, wherein said transfer device of said distribution carriage is formed as a mobile conveyor, said mobile conveyor being at least one selected from the group consisting of a mobile chain, belt and roller conveyor.

13. The buffer store of claim 12, wherein said mobile conveyor has at least two parallel mobile conveyor units that can be operated separately in order to transfer or pick up a plurality of load carriers in parallel.

14. The buffer store of claim 12, wherein said distribution carriage includes an electronic controller.

15. The buffer store of claim 14, wherein said electronic controller of said distribution carriage is arranged in a stationary manner.

16. The buffer store of claim 14, wherein said distribution carriage includes a detector device, said detector device having a data connection to said electronic controller in order to detect whether there is a load carrier on said distribution carriage.

17. The buffer store of claim 16, wherein said detector device comprises a light barrier device.

18. The buffer store of claim 14, wherein said parking places are each provided with a detector device adapted to detect whether a load carrier has passed the gap existing between said stationary conveyor of said parking place and said mobile conveyor of said distribution carriage, each said detector device adapted to have a data connection made selectively to said electronic controller of said distribution carriage.

19. The buffer store of claim 18, wherein the selective data connection between each said detector device and said electronic controller is made in the transfer or pick-up position of said distribution carriage by at least one selected from the group comprising of an inductive coupling and sliding contacts.

20. The buffer store of claim 14, wherein said electronic controller of said distribution carriage includes a follow-up controller, said follow-up controller adapted to selectively operate said electric drive of a said stationary conveyor or operate said mobile conveyor of said distribution carriage following the detection of the passing of the gap between said stationary conveyor and said mobile conveyor in the transfer or pick-up of a load carrier, said follow-up controller operating said electric drive of said stationary conveyor further until the load carrier has reached its intended position on said parking place during a transfer operation and said follow-up controller operating said mobile conveyor of said distribution carriage further until the load carrier has reached its intended position on said distribution carriage during a pick-up operation.

21. The buffer store of claim 4, wherein two rows of said parking places are provided opposite each other with parallel spacing, and wherein said distribution carriage can be moved in the aisle formed between said two rows.

22. The buffer store of claim 4, wherein the movement path of said distribution carriage is formed by rails, and wherein said distribution carriage is supplied from outside with electrical power by at least one selected from the group consisting of sliding contacts, inductively, and drag cables.
